(19) United States
(12) Patent Application Publication
(10) Pub. No.: US 2010/0250525 A1
(43) Pub. Date: Sep. 30, 2010

(54) APPARATUS FOR EVALUATING LIBRARY

(75) Inventors: Koji Shiroyama, Mito (JP); Ichiro Harashima, Hitachioota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/709,374

(22) Filed: Feb. 19, 2010

(30) Foreign Application Priority Data
Mar. 31, 2009 (JP) JP 2009-086469

(51) Int. Cl. G06F 17/30

(52) U.S. Cl. 707/723; 707/769; 707/E17.014

(57) ABSTRACT

Arrangements to evaluate maintenance easiness of a library on the basis of the number of modeling processes required to create a library shape and the number of modeling processes required to model a product by using the created library shape. Such arrangements include, in part, a library score calculating unit that calculates sum of the number of modeling processes and the number of library creating processes from the number of library creating processes calculated by the unit of calculating the number of library creating processes and the number of product modeling processes calculated by the unit of calculating the number of product modeling processes. The plurality of combination plans of library shapes to be evaluated are evaluated on the basis of the sum of the number of modeling processes and the number of library creating processes.

### BACKGROUND OF THE INVENTION

1. Field of the Invention

The present invention relates to an apparatus for evaluating a library and, more particularly, to an apparatus for evaluating a library, that evaluates maintenance easiness of the library on the basis of the number of processes required to model a product.

2. Description of the Related Art

A mechanical CAD system has a function of defining a shape of a part used commonly by a plurality of products as a library shape and modeling a product by disposing the defined library shape. At the time of disposing the library shape, the dimensions can be changed. By properly defining the library shape, the number of modeling processes for modeling a product is reduced, and the maintenance easiness can be improved.

However, the number of modeling processes and the number of library creating processes have a trade-off relation.

For example, when a library shape is made complicated, the number of modeling processes decreases, but the application range of the library shape is narrowed. Consequently, the necessity to newly create a library increases, and the number of processes of creating a new library increases. On the other hand, when a library shape is made simple, the application range is widened. Although the number of processes of creating a new library decreases, the number of modeling processes increases.

Therefore, to reduce the number of modeling processes and the number of processes to maintain a library in future (new library creating processes), a shape library of a proper unit (number of processes) has to be defined in consideration of the application range of a library, version-up span of a product, and the like. Consequently, for a product whose version-up span is long, when time is taken for the number of library creating processes and the number of modeling processes is decreased, the total number of processes becomes smaller. On the other hand, for a product whose version-up span is short, even when a complicated library shape is defined, the period in which the shape can be used is short. Therefore, when the product is modeled by combining simple library shapes which can be generally used, the total number of processes becomes smaller.

The present invention is achieved in view of the above-described drawbacks and provides an apparatus that evaluates maintenance easiness of a library on the basis of the number of modeling processes required to create a library shape and the number of modeling processes required to model a product by using the created library shape.

### SUMMARY OF THE INVENTION

To solve the above-described drawbacks, the present invention employs the following apparatus.

The present invention provides an apparatus for evaluating a library, for evaluating maintenance easiness of a library on the basis of the sum of the number of modeling processes required to create a library shape commonly used by a plurality of products by using a unit process at the time of performing modeling by a CAD and the number of modeling processes required to model a product by using the created library shape, including: a library defining unit of defining a plurality of combination plans of library shapes to be evaluated; a designed-product-shape database that stores CAD data of products designed in the past; a library-using-product retrieving unit that retrieves CAD data of a product using a library defined by the library defining unit from the CAD data stored in the designed-product-shape database; a database of the unit numbers of modeling processes, that stores the unit numbers of modeling processes at the time of performing modeling by a CAD; a unit of calculating the number of library creating processes, that calculates the sum of the number of modeling processes for creating a library for each of the plurality of library combination plans defined by the library defining unit from the unit numbers of modeling processes stored in the database of the unit numbers of modeling processes; a unit of calculating the number of product modeling processes, that calculates the number of processes of modeling a product retrieved by the library-using-product retrieving unit from the unit number of modeling processes stored in the database of the unit number of modeling processes, for each of the plurality of combination plans of libraries defined by the library defining unit; and a library score calculating unit that calculates the sum of the number of modeling processes and the number of library creating processes from the number of library creating processes calculated by the unit of calculating the number of library creating processes and the number of product modeling processes calculated by the unit of calculating the number of product modeling processes. The plurality of combination plans of library shapes to be evaluated are evaluated on the basis of the sum of the number of modeling processes and the number of library creating processes.

According to the present invention with the above configuration, the maintenance easiness of a library can be evaluated on the basis of the number of modeling processes required to create a library shape and the number of modeling processes required to model a product by using the created library shape.

### BRIEF DESCRIPTION OF THE DRAWINGS

Embodiments of the present invention will be described in detail based on the attached drawings, wherein:

FIG. 1 is a diagram for explaining an apparatus for evaluating a library according to a first embodiment;

FIG. 2 is a diagram showing an example of a group of products;

FIG. 3 is a diagram showing library plans defined by a library defining unit;

FIG. 4 is a diagram showing an example of CAD data stored in a designed-product-shape database;

FIG. 5 is a diagram for explaining the details of a library-using-product retrieving unit;

FIG. 6 is a diagram showing an example of matched shapes detected by a shape match detecting unit;

FIG. 7 shows an example of the number of used libraries totaled by a unit for totaling the number of used libraries on a product unit basis;

FIG. 8 is a diagram showing an example of data of units of the number of modeling processes stored in a database of units of the number of modeling processes;

FIG. 9 is a diagram for explaining the details of a unit of calculating the number of library creating processes;

FIG. 10 is a diagram for explaining modeling procedure;

FIG. 11 is a diagram for explaining the details of a library score calculating unit;

FIG. 12 is a diagram showing an example of a calculation result of a unit of calculating the sum of the number of processes;

FIG. 13 is a diagram showing a calculation result of a score calculating unit;

FIG. 14 is a diagram for explaining a second embodiment;

FIG. 15 is a diagram showing an extraction result of a common shape extracting unit;

FIG. 16 is a diagram for explaining the details of a library creating unit;

FIGS. 17A and 17B are diagrams showing extraction results of a common-divided-shape extracting unit;

FIG. 18 is a diagram showing an example of a method (evaluating method) of calculating a score of a library;

FIG. 19 is a diagram showing another example of the method (evaluating method) of calculating a score of a library;

FIG. 20 is a diagram showing the configuration of a library creating apparatus;

FIG. 21 is an external view of a magnetic disk; and

FIG. 22 is an external view of a CD-ROM.

### DETAILED DESCRIPTION OF PREFERRED EMBODIMENTS OF THE PRESENT INVENTION

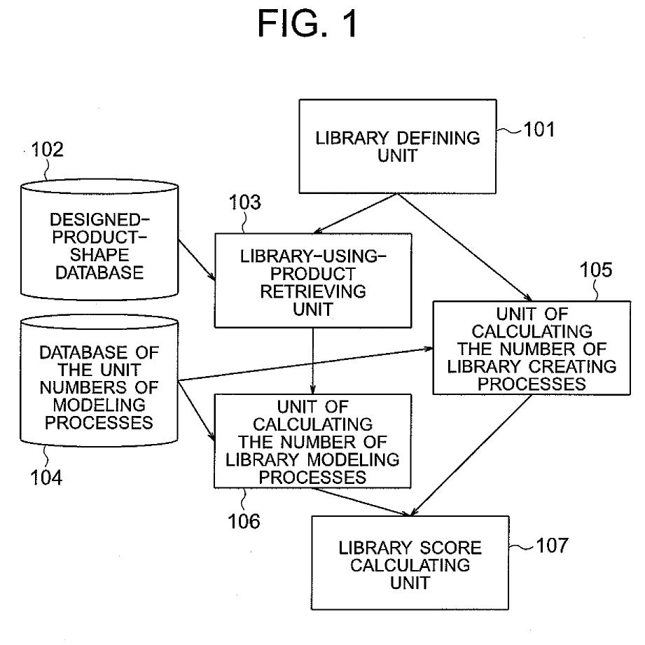

Embodiments will be described below with reference to the appended drawings. FIG. 1 is a diagram illustrating a library evaluating apparatus according to a first embodiment. In FIG. 1, a library defining unit 101 defines a plurality of combination plans of libraries to be evaluated. A designed-product-shape database 102 stores CAD data of products designed in the past. A library-using-product retrieving unit 103 retrieves CAD data of a product using a library defined by the library defining unit 101 from the CAD data stored in the designed-product-shape database 102. A database 104 of the unit number of modeling processes stores the unit number of processes at the time of performing modeling by a CAD, for example, the number of processes required to place a library.

A unit 105 of calculating the number of library creating processes calculates the sum of the number of modeling processes required to create a library for each of the plurality of combination plans of libraries defined by the library defining unit 101 on the basis of the unit number of modeling processes stored in the database 104 of the unit number of modeling processes.

A unit 106 of calculating the number of product modeling processes calculates the number of processes of modeling a product retrieved by the library-using-product retrieving unit 103 for each of the plurality of combination plans of libraries defined by the library defining unit 101 on the basis of the unit number of modeling processes stored in the database 104 of the unit number of modeling processes.

A library score calculating unit 107 calculates a score of a library from the number of library creating processes calculated by the unit 105 of calculating the number of library creating processes and the number of product modeling processes calculated by the unit 106 of calculating the number of product modeling processes.

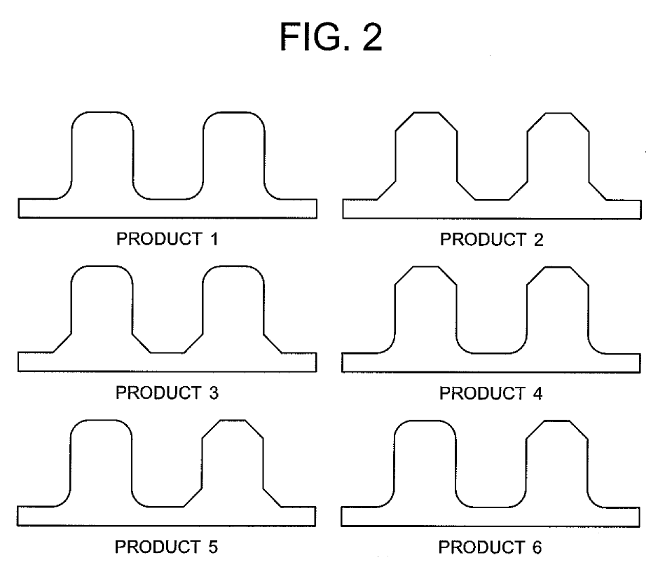

A product group of rotating bodies having sections shown in FIG. 2 will be described as an example below.

The library defining unit 101 defines a plurality of combination plans of libraries to be evaluated. A library is defined by, for example, a method of creating a shape in a manner similar to newly model a product, a method of selecting a partial shape of a created product which has been already modeled, or the like.

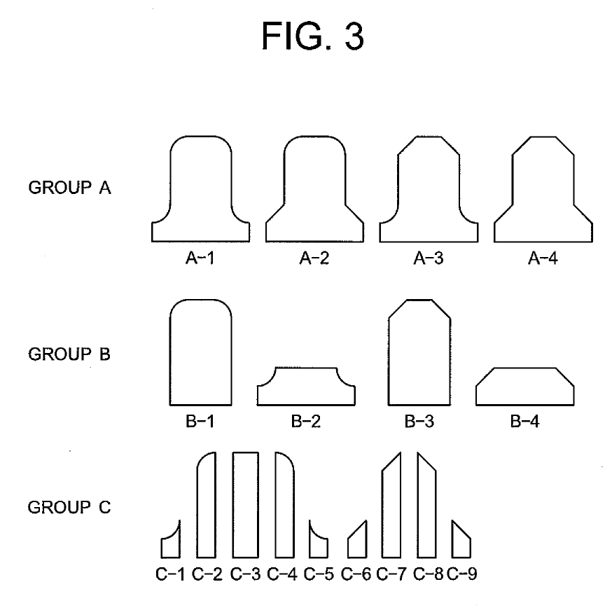

FIG. 3 shows the library plans defined by the library defining unit 101. Three library plans of groups A, B, and C are defined. Four library shapes are defined in each of the groups A and B, and nine library shapes are defined in the group C.

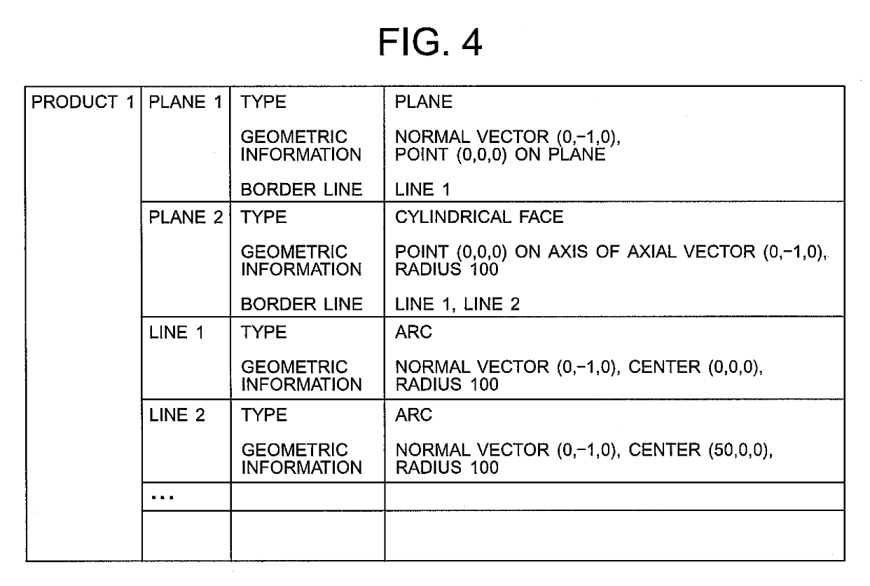

The designed-product-shape database 102 in FIG. 2 stores CAD data of products designed in the past. FIG. 4 shows an example of CAD data stored in the designed-product-shape database 102. As shown in FIG. 4, a shape is expressed by type and geometric information on the plane/line unit basis, and line information of borders of a plane.

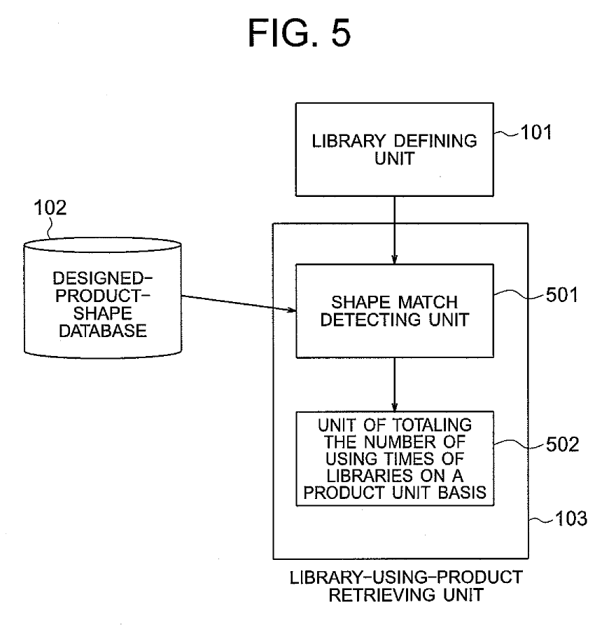

FIG. 5 is a diagram illustrating the details of the library-using-product retrieving unit 103. In FIG. 5, a shape match detecting unit 501 detects a match between the CAD data stored in the designed-product-shape database 102 and each of the library shapes in a plurality of combination plans of libraries defined by the library defining unit 101.

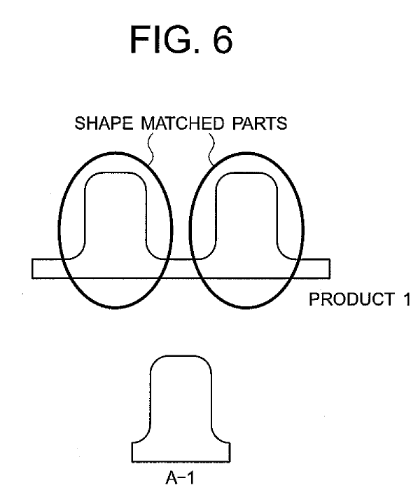

FIG. 6 shows an example of matched shapes detected by the shape match detecting unit 501. Two parts in a product 1 in bold-line circles match a library shape A-1. A unit 502 for totaling the number of using times of libraries on a product unit basis totals the number of matched shapes detected by the shape match detecting unit 501.

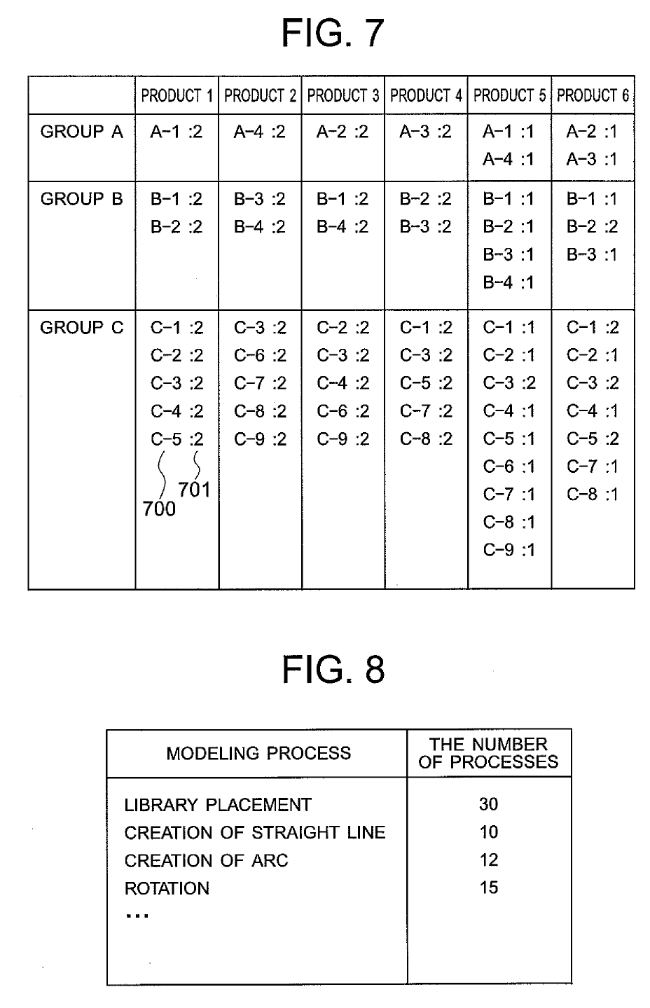

FIG. 7 shows an example of the numbers of using times of libraries totaled by the unit 502 for totaling the number of using times of libraries on a product unit basis. The number of using times of each of the libraries is totaled for each library combination. 701 denotes a library shape, and 702 denotes the number of matches.

In FIG. 1, the database 104 of the unit number of modeling processes stores the unit number of processes of performing modeling by a CAD, for example, the number of processes to place a library. FIG. 8 shows an example of data of the unit numbers of modeling processes stored in the database 104 of the unit number of modeling processes.

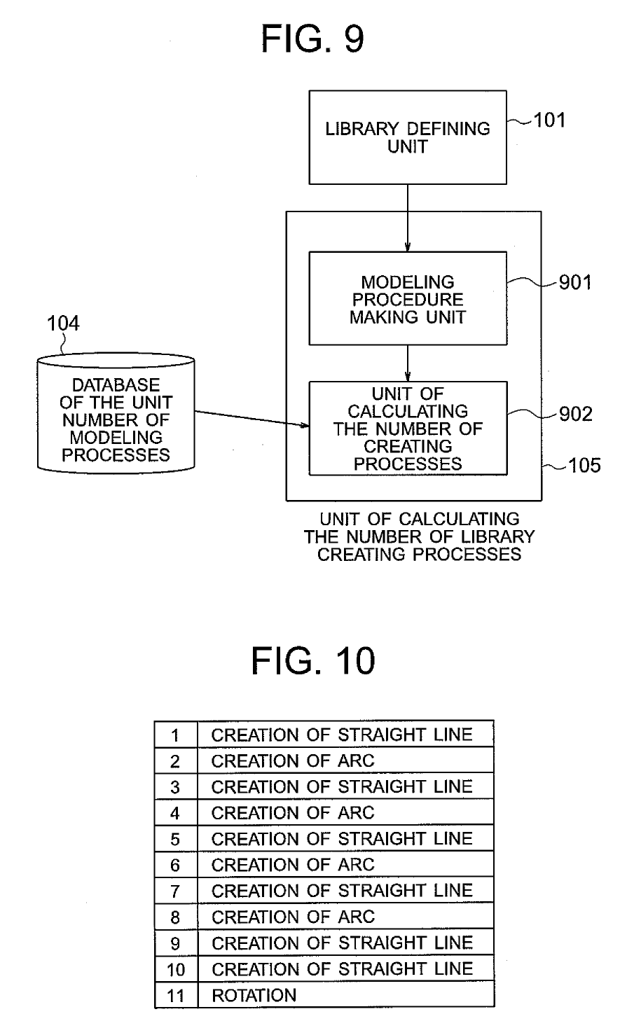

FIG. 9 is a diagram for explaining the details of the unit 105 of calculating the number of library creating processes. A modeling procedure making unit 901 makes a procedure of modeling each of libraries constructing a plurality of combination plans of libraries defined in the library defining unit 101. FIG. 10 shows a procedure of modeling the library shape A-1 as an example. A unit 902 of calculating the number of creating processes calculates the number of creating processes by library on the basis of the modeling procedure made by the modeling procedure making unit 901 and the data of unit numbers stored in the database 104 of the unit number of modeling processes. In the example (modeling of A-1) of FIG. 10, the number of creation times of straight line is six, the number of creation times of arc is four, and the number of rotation times is once, so that the number of creating processes is 10×6+12×4+15=123.

The unit 106 of calculating the number of product modeling times calculates the number of modeling processes for each products from the number of used libraries for each product counted by the unit 502 for totaling the number of used libraries for each product, and the unit number of modeling processes stored in the database 104 of the unit number of modeling processes. For example, in the case of modeling the product 1 with the group A, since the number of placing a library is twice, the number of modeling processes is 60.

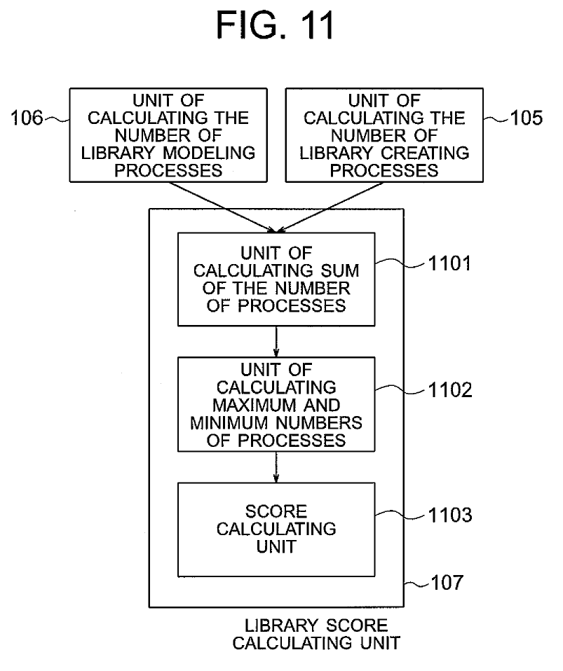

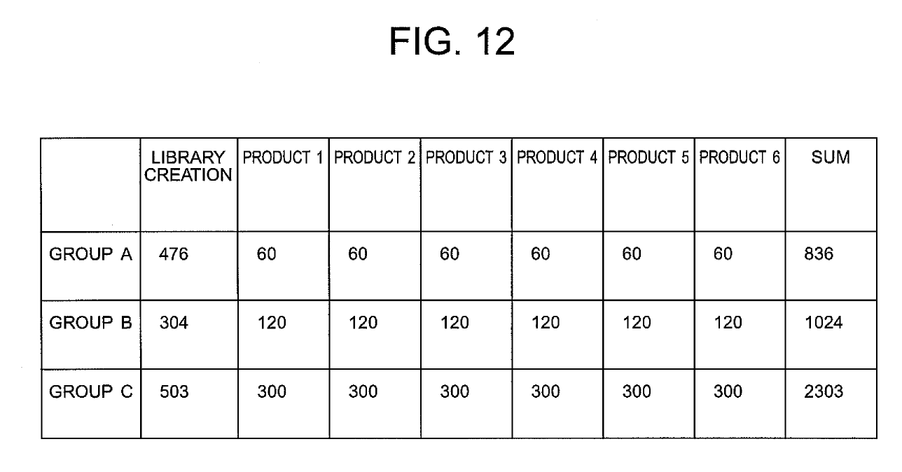

FIG. 11 is a diagram for explaining the details of the library score calculating unit 107. In FIG. 11, a unit 1101 of calculating sum of the number of processes calculates the sum of the number of library creating processes and the number of processes for modeling a product for each of combinations of libraries. FIG. 12 shows the calculated sums of processes. A unit 1102 of calculating the maximum and minimum numbers of processes obtains the maximum and minimum values from the sums of processes for each of the combinations of libraries calculated by the unit 1101 of calculating sum of the number of processes. A score calculating unit 1103 calculates a score from the sum of the numbers of processes for each of combinations of libraries calculated by the unit 1101 of calculating sum of the number of processes and the maximum and minimum values calculated by the unit 1102 of calculating the maximum and minimum numbers of processes. A score is calculated by, for example, the following formula.

(maximum value−sum of the numbers of processes)*100/(maximum value-minimum value)

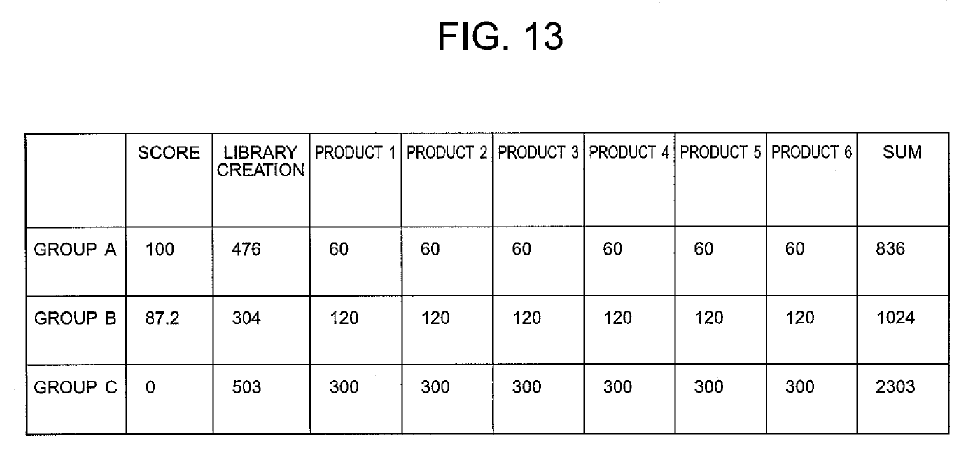

In the formula, the sum of processes is 100 points in the minimum case and zero point in the maximum case. In the case of FIG. 12, the group A is the minimum case so that the score is 100 points. The score of the group B is 87.2 points, and that of the group C is zero point. As the score, only the score may be displayed or the score and the number of modeling processes may be displayed as shown in FIG. 13.

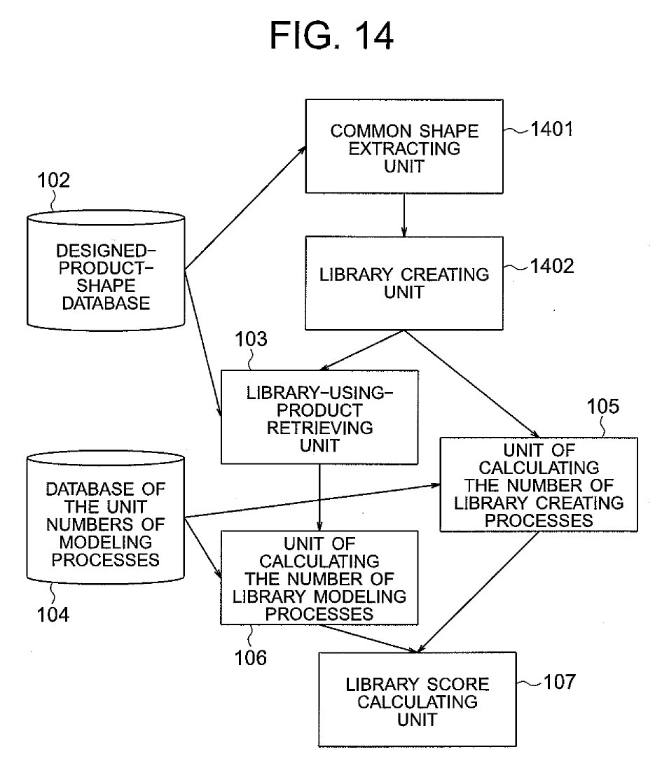

FIG. 14 is a diagram for explaining a second embodiment. In the first embodiment, the user calculates scores of a plurality of combination plans of libraries defined. In the second embodiment, a common shape is extracted from designed-product-shape data, a combination plan of a plurality of libraries is made, and a score is calculated.

In FIG. 14, the designed-product-shape database 102 stores CAD data of products designed in the past. A common shape extracting unit 1401 extracts a partial shape common to a plurality of products from shape data of designed products stored in the designed-product shape database 102. A library creating unit 1402 creates a plurality of library combinations from the common shapes extracted by the common shape extracting unit 1401.

The library-using-product retrieving unit 103 retrieves the CAD data of a product using a library created by the library creating unit 1402 from the CAD data stored in the designed-product-shape database 102. The database 104 of the unit number of modeling processes stores the unit number of processes at the time of performing modeling by a CAD, for example, the number of processes required to place a library. The unit 105 of calculating the number of processes of creating a library calculates the sum of the number of modeling processes for each of combination plans of a plurality of libraries created by the library creating unit 1402 from the unit numbers of modeling processes stored in the database 104 of the unit number of modeling processes. The unit 106 of calculating the number of processes of modeling a product calculates the number of processes of modeling the product retrieved by the library-using-product retrieving unit 103 from the unit numbers of modeling processes stored in the database 104 of the unit number of modeling processes for each of the plurality of combination plans of libraries created by the library creating unit 1402. The library score calculating unit 107 calculates the score of a library from the number of library creating processes calculated by the unit 105 of calculating the number of library creating processes and the number of product modeling processes calculated by the unit 106 of calculating the number of product modeling processes.

Using the product group shown in FIG. 2 as an example, the common shape extracting unit 1401 extracts shapes as shown in FIG. 15 as common shapes. The extraction is executed by comparison with shapes of the created data stored in the designed-product-shape database 102.

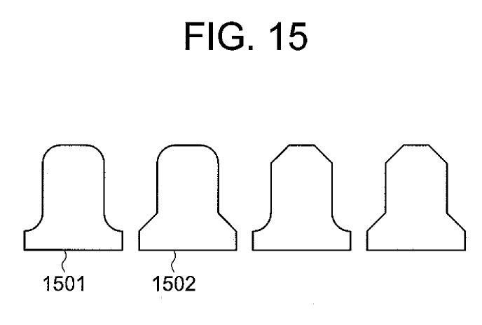

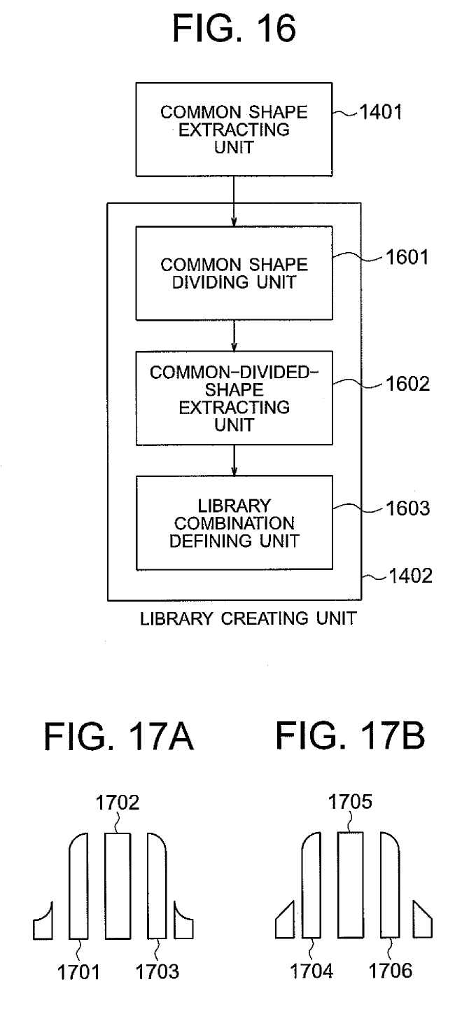

FIG. 16 is a diagram for explaining the details of the library creating unit 1402. In FIG. 16, a common shape dividing unit 1601 divides a common shape extracted by the common shape extracting unit 1401. For example, in a case 1501 shown in FIG. 15, the common shape is divided into pieces as illustrated in FIG. 17A. In a case 1502, the common shape is divided into pieces as illustrated in FIG. 17B.

A common-divided-shape extracting unit 1602 extracts a common shape of the pieces divided by the common shape dividing unit 1601. In the cases of FIG. 17, pieces 1701 and 1704 are extracted as a common shape, pieces 1702 and 1705 are extracted as a common shape, and pieces 1703 and 1706 are extracted as a common shape.

A library combination defining unit 1603 defines combinations of the common shapes extracted by the common-divided-shape extracting unit 1602 as combinations of library shapes. In the case of the product group of FIG. 2, for example, combinations of the library shapes as shown in FIG. 3 are defined.

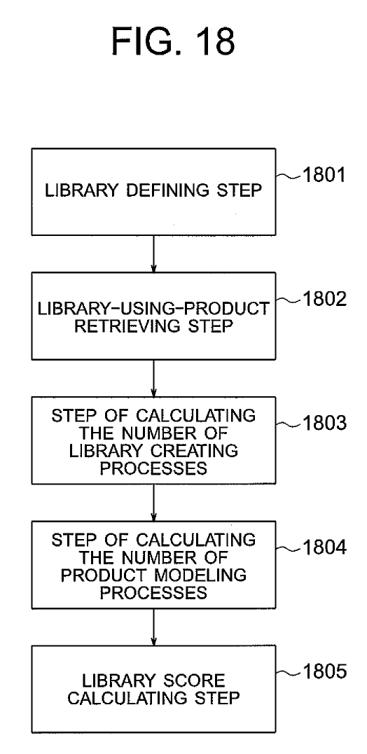

FIG. 18 is a diagram showing an example of a method (evaluation method) of calculating a score of a library. In library defining step 1801, a combination plan of a plurality of libraries to be evaluated is defined. In library-using-product retrieving step 1802, CAD data of a product using the library defined in the library defining step 1801 is retrieved from CAD data of products designed in the past. In step 1803 of calculating the number of library creating processes, the sum of the number of modeling processes is calculated for each of the plurality of library combination plans defined in the library defining step 1801 from the number of unit modeling processes. In a step 1804 of calculating the number of product modeling processes, the number of processes of modeling the product retrieved in the library-using-product retrieving step 1802 is calculated for each of the plurality of combination plans of libraries defined in the library defining step 1801. In a library score calculating step 1805, the score of the library is calculated from the number of library creating processes calculated in the step 1803 of calculating the number of library creating processes and the number of product modeling processes calculated in the step 1804 of calculating the product modeling processes.

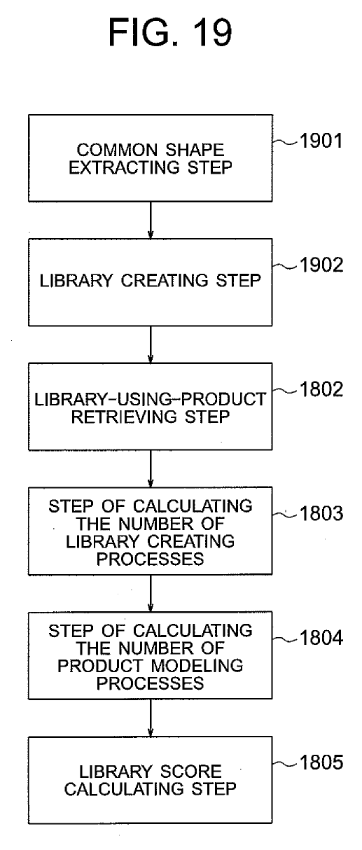

FIG. 19 is a diagram showing another example of a method (evaluation method) of calculating a score of a library. In common shape extracting step 1901, a partial shape common to a plurality of products is extracted from shape data of created products by comparison with the created shape data. In library creating step 1902, a plurality of plans of library combinations are made by dividing the common shape extracted in the common shape extracting step 1901 from the common shape. In the library-using-product retrieving step 1802, CAD data of a product using the library defined in the library defining step 1801 is retrieved from CAD data of products designed in the past. In the step 1803 of calculating the number of library creating processes, the sum of the number of modeling processes is calculated for each of the plurality of library combination plans created in the library creating step 1902 from the number of unit modeling processes. In the step 1804 of calculating the number of product modeling processes, the number of processes of modeling the product retrieved in the library-using-product retrieving step 1802 is calculated for each of the plurality of combination plans of libraries defined in the library defining step 1801. In the library score calculating step 1805, the score of the library is calculated from the number of library creating processes calculated in the step 1803 of calculating the number of library creating processes and the number of product modeling processes calculated in the step 1804 of calculating the product modeling processes.

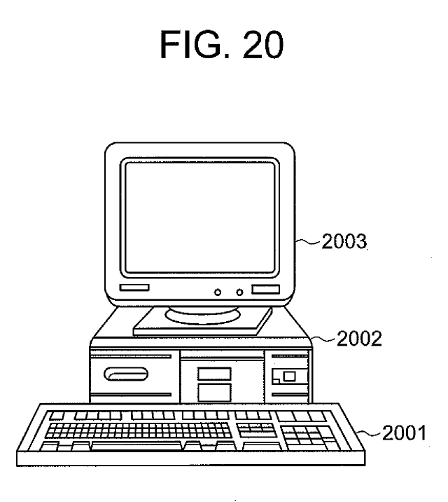

FIG. 20 is a diagram showing the configuration of a library creating apparatus. The apparatus can be realized by a general computer system constructed by a keyboard 2001, a computer body 2002 having an input section that enters data and a process program as described above, a storage that stores the entered data and program, an arithmetic unit, and the like, and a display 2003, and a process program operating on the computer system. In the apparatus of the embodiment, basically, process is executed by a procedure expressed by the flowchart of FIG. 18 or the like. The apparatus can be also constructed as a dedicated apparatus.

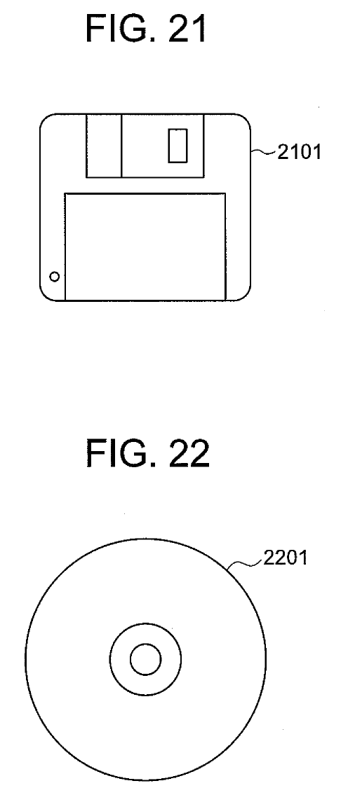

When the invention is realized by adding a process program to a general computer system, the process program is recorded on a medium such as a magnetic disk 2101 as shown in FIG. 21 or a CD-ROM as shown in FIG. 22, distributed, stored, implemented, read by a magnetic disk reader or a CD-ROM reader provided for the computer body 2002, and loaded into the computer body 2002.

In the case of loading a process program distributed via a communication network by the input section and realizing it, by storing the loaded process program on a medium such as a magnetic disk, the process program can be used repeatedly.

As described above, according to the embodiment of the invention, the score of a library in which maintenance easiness of the library is also considered can be obtained on the basis of the sum of the number of library creating processes and the number of product modeling processes for each of a plurality of library combination plans.

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus for evaluating a library, for evaluating maintenance easiness of the library on the basis of the sum of the number of modeling processes required to create a library shape commonly used by a plurality of products by using a unit process at the time of performing modeling by a CAD and the number of modeling processes required to model a product by using the created library shape, comprising:
a library defining unit of defining a plurality of combination plans of library shapes to be evaluated;
a designed-product-shape database that stores CAD data of products designed in the past;
a library-using-product retrieving unit that retrieves CAD data of a product using a library defined by the library defining unit from the CAD data stored in the designed-product-shape database;
a database of the unit numbers of modeling processes, that stores the unit numbers of modeling processes at the time of performing modeling by the CAD;
a unit of calculating the number of library creating processes, that calculates the sum of the number of modeling processes for creating a library for each of the plurality of library combination plans defined by the library defining unit from the unit numbers of modeling processes stored in the database of the unit numbers of modeling processes;
a unit of calculating the number of product modeling processes, that calculates the number of processes of modeling the product retrieved by the library-using-product retrieving unit from the unit number of modeling processes stored in the database of the unit number of modeling processes, for each of the plurality of combination plans of libraries defined by the library defining unit; and
a library score calculating unit that calculates the sum of the number of modeling processes and the number of library creating processes from the number of library creating processes calculated by the unit of calculating the number of library creating processes and the number of product modeling processes calculated by the unit of calculating the number of product modeling processes,
wherein the plurality of combination plans of library shapes to be evaluated are evaluated on the basis of the sum of the number of modeling processes and the number of library creating processes.

2. The apparatus for evaluating a library according to claim 1, wherein the library score calculating unit comprises:
a unit of calculating the sum of processes, that calculates the sum of the number of library creating processes and the number of product modeling processes for each of combinations of libraries;
a unit of calculating the maximum and minimum numbers of processes, that obtains the maximum and minimum values from the sum of the processes for each of the library combinations calculated by the unit of calculating sum of processes; and
a score calculating unit that calculates a score from the sum of processes for each library combination calculated by the unit of calculating the sum of processes and the maximum and minimum values calculated by the unit of calculating the maximum and minimum numbers of processes.

3. The apparatus for evaluating a library according to claim 1, wherein the library defining unit creates a library by extracting a partial shape common to a plurality of products by comparison with designed shape data from the shape data of designed products stored in the designed-product-shape database that stores the CAD data of the products designed in the past.

4. The apparatus for evaluating a library according to claim 3, wherein a library creating unit comprises:
a common shape dividing unit that divides a common shape extracted by a common shape extracting unit into pieces;
a common-divided-shape extracting unit that extracts a common shape of shapes divided by the common shape dividing unit; and
a library combination defining unit that defines a combination of the common shapes extracted by the common-divided-shape extracting unit as a combination of library shapes.

5. The apparatus for evaluating a library according to claim 3, wherein the library score calculating unit comprises:
the unit of calculating the sum of processes, that calculates the sum of the number of library creating processes and the number of product modeling processes for each of combinations of libraries;
the unit of calculating the maximum and minimum numbers of processes, that obtains the maximum and minimum values from the sum of the processes for each of the library combinations calculated by the unit of calculating sum of processes; and
the score calculating unit that calculates a score from the sum of processes for each library combination calculated by the unit of calculating the sum of processes and the maximum and minimum values calculated by the unit of calculating the maximum and minimum numbers of processes.

6. A library evaluating method comprising the steps of:
defining a plurality of combination plans of library shapes to be evaluated;
retrieving CAD data of a product using the defined library from CAD data of products designed in the past and stored in a designed-product-shape database;
calculating the sum of the number of modeling processes for creating libraries for each of the plurality of combination plans of defined libraries from the unit number of modeling processes stored in the database of the unit numbers of modeling processes;
calculating the number of product modeling processes, of calculating the number of processes of modeling a product retrieved in the library-using-product retrieving step from the number of unit modeling processes stored in the database of the number of unit modeling processes, for each of the plurality of combination plans of libraries defined in the library defining step; and
calculating a score of a library, of calculating the sum of the number of modeling processes and the number of library creating processes from the number of library creating processes calculated in the step of calculating the number of library creating processes and the number of product modeling processes calculated in the step of calculating the number of product modeling processes,
wherein the plurality of combination plans of library shapes to be evaluated are evaluated on the basis of the sum of the number of modeling processes and the number of library creating processes.

7. A library evaluating method comprising the steps of:
extracting a partial shape common to a plurality of products from CAD data of products designed in the past and stored in a designed-product-shape database by comparison with designed shape data;
making a plurality of combination plans of libraries by dividing a common shape from the common shape extracted in the common-shape extracting step;
retrieving CAD data of a product using a library created in the library creating step from the CAD data stored in the designed-product-shape database;
calculating the sum of the number of modeling processes from the unit numbers of modeling processes stored in a database of the unit numbers of modeling processes, that stores the unit numbers of performing modeling by a CAD for each of the plurality of combination plans of libraries created in the library creating step;
calculating the number of modeling processes of a product retrieved in the library-using-product retrieving step from the unit numbers of modeling processes stored in the database of unit numbers of modeling processes for each of the plurality of combination plans of libraries created in the library creating step; and
calculating a score of a library from the number of library creating processes calculated in the step of calculating the number of library creating processes and the number of product modeling processes calculated in the step of calculating the number of product modeling processes,
wherein the plurality of combination plans of libraries to be evaluated are scored on the basis of the sum of the number of modeling processes and the number of library creating processes.
